(19) United States
(12) Patent Application Publication
(10) Pub. No.: US 2007/0204076 A1
(43) Pub. Date: Aug. 30, 2007

(54) Method and apparatus for burst transfer

(75) Inventors: Ambalavanar Arulambalam, Macungie, PA (US); Cheng Gang Duan, Shanghai (CN); Yun Peng, Shanghai (CN); Qian Gao Xu, Shanghai (CN); Jun Chao Zhao, Shanghai (CN)

Correspondence Address: DUANE MORRIS, LLP;IP DEPARTMENT, 30 SOUTH 17TH STREET, PHILADELPHIA, PA, 19103-4196, US

(73) Assignee: Agere Systems Inc.

(21) Appl. No.: 11/364,979

(22) Filed: Feb. 28, 2006

(51) Int. Cl. G06F 13/00

(52) U.S. Cl. 710/35

(57) ABSTRACT

A method includes receiving a burst access request for transfer of data between a memory and a first bus. The burst access request specifies an amount of data that is at least a multiple of an amount of data transferred in one beat. A single memory request is issued, instructing the memory to transfer the specified amount of data between the memory and a buffer coupled to the first bus. The specified amount of data is transferred between the buffer and the first bus in a plurality of beats.

### FIELD OF THE INVENTION

The present invention relates to memory access methods and apparatus, and specifically to burst data transfer methods and apparatus.

### BACKGROUND

The advanced microcontroller bus architecture (AMBA) advanced high-performance bus (AHB) specification requires the ability to process several different types of burst data transfer requests. Instead of having a requestor issue sequential memory addresses for a multiple-word read or write operation, the requestor issues a signal indicating the number of bytes to be transferred and the transfer type. Then the memory transfer takes place automatically. This type of transfer is called a burst mode, of which there are several types: incrementing, increment 4, 8 or 16 and wrap 4, 8 or 16. The list of burst transfer types used in the AMBA AHB architecture is set forth in table 1:

TABLE 1

| Code | Type | Description |
|---|---|---|
| 000 | SINGLE | Single transfer |
| 001 | INCR | Incrementing burst of unspecified length |
| 010 | WRAP4 | 4-beat wrapping burst |
| 011 | INCR4 | 4-beat incrementing burst |
| 100 | WRAP8 | 8-beat wrapping burst |
| 101 | INCR8 | 8-beat incrementing burst |
| 110 | WRAP16 | 16-beat wrapping burst |
| 111 | INCR16 | 16-beat incrementing burst |

In the case of 4, 8 and 16 beat incrementing bursts, the size of the data transfer is greater than the AMBA AHB bus width, so that an access to the data in memory requires multiple beats. Each beat transfers a programmable amount of data equal to the programmable bus width. The AMBA AHB bus width is indicated by HSIZE, and may be, for example, one byte, one half-word (16-bits) or a full word (32-bits).

The conventional approach to handling a 4, 8 or 16 beat burst transfer request is to break the request up into multiple (i.e., 4, 8 or 16) single beat transactions. A respective memory access request is issued for each of the single beat transactions.

In the case of a wrapping burst transfer, the request specifies that the memory should return the data beginning at an address other than the first byte in the word. The conventional approach to handling 4, 8 or 16 beat wrapping burst requests includes dividing each word request into two requests: a first request from the requested address to the end of the word, and a second request from the start of the word to the byte that precedes the starting address.

The conventional approaches for handling multiple beat burst transfer requests and wrapping burst requests using the AMBA AHB bus thus involve increased overhead. This causes delays in obtaining the critical data in time to support operations. Delays in getting high priority information to the requesting processor lead to poor performance in the number of instructions executed. The access latency is increased, and effective memory access bandwidth is reduced.

### SUMMARY

In some embodiments, a method comprises receiving a burst access request for transfer of data between a memory and a first bus. The burst access request specifies an amount of data that is at least a multiple of an amount of data transferred in one beat. A single memory request is issued, instructing the memory to transfer the specified amount of data between the memory and a buffer coupled to the first bus. The specified amount of data is transferred between the buffer and the first bus in a plurality of beats.

In some embodiments, an apparatus comprises a first bus. A first slave receives a burst access request for transfer of data between a memory and the first bus. The burst access request specifies an amount of data that is at least a multiple of an amount of data to be transferred in one beat. A buffer is coupled to the first slave. A request forming unit issues a single memory request instructing the memory to transfer the specified amount of data between the memory and the buffer. The slave transfers the specified amount of data between the buffer and the first bus in a plurality of beats.

### BRIEF DESCRIPTION OF THE DRAWINGS

FIG. 1 is a block diagram of an exemplary network attached storage system.

FIG. 2 is a block diagram of the AMBA AHB data and instruction bus interfaces shown in FIG. 1

FIGS. 3A and 3B are a flow chart showing an exemplary method for handling burst requests using the interface of FIG. 2.

FIG. 4 is a flow chart diagram showing prioritization among request types in the interface shown in FIG. 2.

### DETAILED DESCRIPTION

This description of the exemplary embodiments is intended to be read in connection with the accompanying drawings, which are to be considered part of the entire written description.

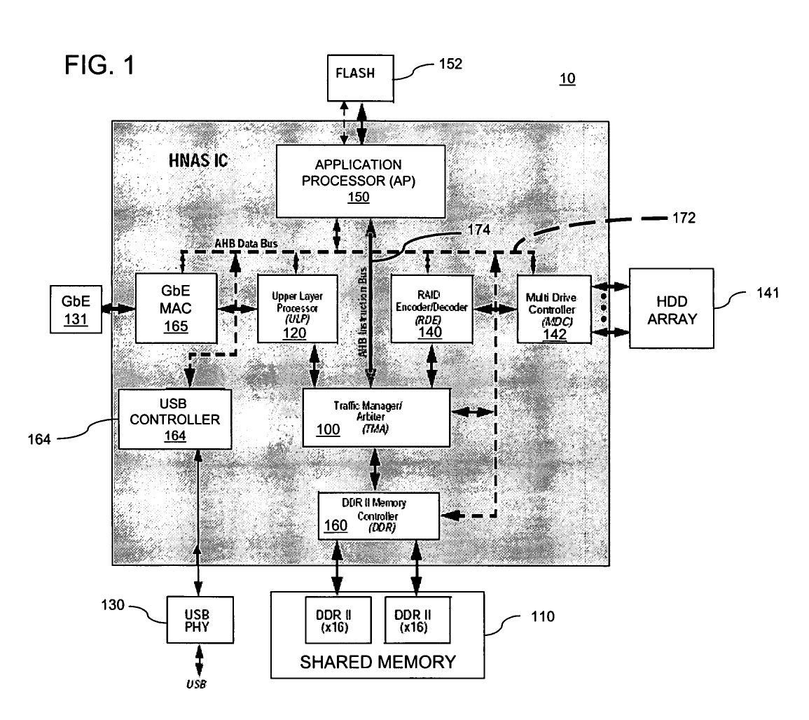

FIG. 1 is a block diagram of an exemplary home media server and network attached storage (HNAS) system 10 for a home media server application, which may be implemented as a system on a chip (SOC). In HNAS system 10, data from multiple sessions are concurrently stored to a disk array 141, played out to devices on a home network via USB port 130 or Ethernet port 131, and/or used for control traffic. The term “session” broadly encompasses any open connection that has activity, in which data are being received from the media interface and stored in the disk 141 (or other mass storage device), being read out from the disk 141 to a local device (e.g., TV, stereo, computer or the like) or a network, or any open connection used by control or application processor (AP) 150 for processor functions that operate system 10 (e.g., retrieving data or instructions from memory 110, reading from or writing to registers). The sessions use a shared memory 110 as an intermediate storage medium.

AP 150 may be an embedded ARM926EJ-S core by ARM Holdings, plc, Cambridge, UK, or other embedded microprocessor. In FIG. 1, AP 150 is coupled to other elements of the system by two different buses: an instruction bus 174 and a data bus 172. In some embodiments, both the instruction and data buses 174, 172 are AMBA AHB buses.

AP 150 is coupled to a Traffic Manger Arbitrator (TMA) 100 and flash memory 152 via the instruction bus 174. TMA 100 includes an exemplary memory controller interface 161. TMA 100 manages i) storage of media streams arriving via Ethernet port 131, ii) handling of control traffic for application processing, and iii) playback traffic during retrieval from the HDD array 141. TMA 100 controls the flow of all traffic among the network interface 165, USB controller 164, memory 110, AP 150, and HDD array 141.

In some embodiments, the memory 110 is implemented by a single-port DDR-2 DRAM. Double Data Rate (DDR) synchronous dynamic random access memory (SDRAM) is high-bandwidth DRAM technology. Other types of memory may be used to implement shared memory 110.

AP 150 is also coupled to flash memory 152, TMA 100, Gigabit Ethernet media access control (GbE MAC) module 131, Upper Layer Protocol (ULP) module 120, RAID decoder/encoder (RDE) module 140 (where RAID denotes redundant array of inexpensive disks), USB controller 164, and multi drive controller (MDC) 142 via a data bus 172.

AP 150 accesses shared memory 110 for several reasons. Part of shared memory 110 contains program instructions and data for AP 150. The AMBA AHB Instruction Bus (IB) 174 may access shared memory 110 to get instruction/program data on behalf of AP 150. Also, the control traffic destined for AP 150 inspection is stored in shared memory 110. In some embodiments, AMBA AHB IB 174 has read access to shared memory 110, but the AMBA AHB data bus (DB) 172 is provided both read and write access to memory 110. AP 150 uses the write access to AHB DB 172 to re-order data packets (e.g., TCP packets) received out-of-order. Also, AP 150 may insert data in and extract data from an existing packet stream in the shared memory 110.

The AHB DB 172 and AHB IB 174 access shared memory 110 on behalf of AP 150 frequently. AHB DB 172 is primarily used to access the internal register space and to access the data portion of the external shared memory. AHB IB 174 is used to access instructions specific to AP 150, that are stored in shared memory 110. According to the AMBA Specification (Rev2.0), multiple burst modes may be used to improve the efficiency of the buses 172, 174. The burst type information is provided in table 1, above.

The system 10 receives media objects and control traffic from the network port 131 and the objects/traffic are first processed by the local area network controller (e.g., Gigabit Ethernet controller GbE MAC 165) and the ULP accelerator 120. The ULP accelerator 120 transfers the media objects and control traffic to the TMA 100, and the TMA 100 stores the arriving traffic in the shared memory 110. In the case of media object transfers, the incoming object data are temporarily stored in the memory 110, and then transferred to RDE 140 for storage in disk 141. The TMA 100 also manages the retrieval requests from disk 141 toward the LAN interface 131. While servicing media playback requests, the data are transferred from disk 141 and stored in buffers in memory 110. The data in the buffers are then transferred out to the GbE port 131 via the ULP accelerator 120. The data are formed into packets for transmission using TCP/IP, with the ULP accelerator 120 performing routine TCP protocol tasks to reduce the load on the control processor 150. TMA 100 manages the storage to and retrieval from the HDD array 141 by providing the appropriate control information to RDE 140.

The control traffic destined for inspection by AP 150 is also stored in the shared memory 110, and AP 150 is given access to read the packets in memory 110. AP 150 also uses this mechanism to re-order any of the packets received out-of-order. A part of the shared memory 110 and disk 141 contains program instructions and data for AP 150. TMA 100 manages the access to memory 110 and disk 141 by transferring control information from disk to memory and memory to disk. TMA 100 also enables AP 150 to insert data and extract data to and from an existing packet stream.

The memory controller interface 161 provides the interface for managing accesses to memory 110 via a single memory port. RDE module 140 (where “RDE” denotes RAID decoder encoder, and “RAID” denotes redundant array of inexpensive disks) is connected to the HDD array 141. A network interface, GbE MAC 165, provides the interface to the local area network, GbE 131. USB controller 164 provides the interface between the TMA 100 and the USB port 130 (USB port 130 may be a USB 2.0 (or higher) port).

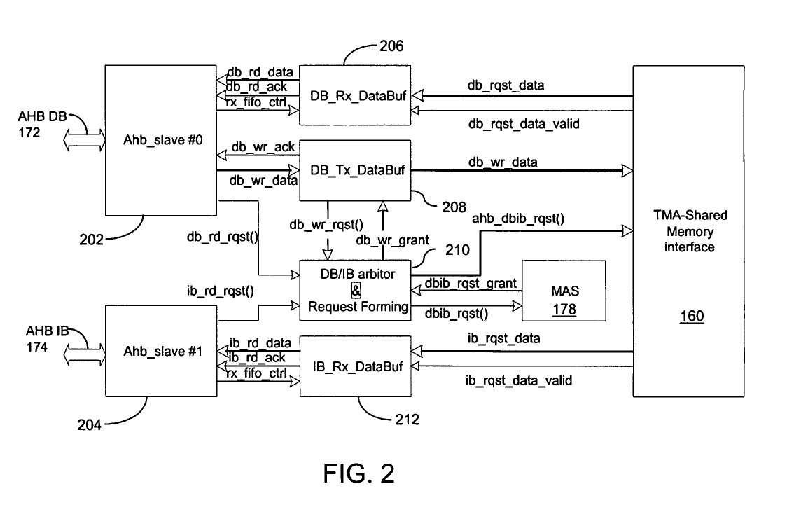

FIG. 2 is a block diagram of exemplary apparatus for handling communications between AP 150 and the shared memory interface 161 via the instruction bus 174 and data bus 172. Shared memory Interface 161 provides an interface to the memory controller 160 (FIG. 1).

Each bus 172, 174 has a respective AHB slave 202, 204. Each slave 202, 204 is capable of receiving a burst access request for transfer of data between the memory 110 and its respective bus 172, 174. In some embodiments, the burst access request can be a request for any of the request types specified in the AMBA AHB specification, and listed in Table 1. The set of request types include requests for an amount of data that is one or more times the amount of data to be transferred in one beat (e.g., 1, 4, 8 and 16 beats). Slaves 202 and 204 detect the start of a burst transfer, the burst type, the start address, hsize, and the request type (read or write). Once one of the slaves 202 or 204 detects a burst transfer request, the AHB bus 172 or 174 that caused the transfer waits, while the burst transfer request is processed by the DB/IB arbiter and request forming unit 210 to formulate an AHB IB request.

At least one buffer is coupled to each of the AHB slaves 202, 204. In the example of FIG. 2, the data bus slave 202 is connected to two buffers: a data receive buffer DB₋Rx₋DataBuf 206 and a data transmit buffer DB₋Tx₋DataBuf 208. In the embodiment of FIG. 2, AHB IB 174 is used for memory read accesses (but not memory write access), and the instruction bus slave 204 is connected to one buffer IB₋RX₋DataBuf 212. In other embodiments (not shown), the instruction bus may also be used for memory write accesses, and an additional buffer (not shown) is provided for that purpose.

A data bus/instruction bus (DB/IB) request forming unit 210 issues a single memory request instructing the memory 110 to transfer the specified amount of data between the memory 110 and the appropriate buffer 206, 208 or 212 corresponding to the burst access request being serviced. For example, if a 16 beat incrementing burst request for data stored in memory 110 is being serviced, then request forming unit 210 issues a single memory request for 64 bytes (if the beat size is 4-bytes) of data to the memory 110, and 64 bytes are transferred to the buffer DB₋Rx₋DataBuf 206. There is no need to break the request up into a plurality of smaller memory access requests.

A memory access scheduler (MAS) 178 manages memory access bandwidth and provides a prescribed quality of service (QoS), in the form of allocated bandwidth and latency guarantees for media objects during playback. The MAS 178 is responsible for the bandwidth distribution among each media session, while request forming unit 210 manages multiple memory access requests from AP 150 via AHB DB 172 and AHB IB 174. Request forming unit 210 issues requests (dbib₋rqst) to MAS 178, and waits for a grant signal (dbib₋rqst_grant) from MAS 178. When MAS 178 provides the grant signal (dbib₋rqst_grant) to request forming unit 210, request forming unit 210 issues the memory access requests (ahb_dbib₋rqst) to memory interface 160 on behalf of AHB DB 172 and AHB IB 174.

The request forming unit 210 arbitrates among various DB/IB memory access requests and generates a single memory access request for any of the allowable burst transfer types (1, 4, 8 or 16 beats, incrementing or wrapping burst, memory read or memory write). In the exemplary embodiment, internal register accesses by AP 150 (as opposed to memory accesses) are not arbitrated, and are allowed even if a prior data bus request is waiting to be serviced.

Request forming unit 210 schedules the instruction and the data bus memory access requests. In some embodiments, request forming unit 210 provides strict priority to give AHB IB 174 accesses to memory 110 priority over the AHB DB 172 accesses to memory 110. When AHB IB 174 is idle, a request is granted to AHB DB 172, so that it can access memory 110. Request forming unit 210 arbitrates between the data read and data write access requests.

To service wrapping burst requests, request forming unit 210 includes means for determining an address boundary in the memory preceding a starting address specified in the wrapping burst access request. If the start address of the transfer is not aligned to the total number of bytes in the burst (size×number of beats), request forming unit 210 is responsible for determining the lowest address of the transfer, to be used as the request address forwarded to the memory interface 161. As a result, the data fed back by the shared memory 110 are in ascending order from the lowest address. For example, for a memory having addresses aligned on 64-bit boundaries, the address boundary preceding the starting address for the transfer to/from memory 110 can be determined by a performing a modulo-64 division and multiplying the result by 64. Modulo division followed by multiplication also provides the correct starting address for the transfer to/from memory 110 for an incrementing burst (since there is no remainder), so the same set of operations can be used to determine the starting address of the memory access for all the allowable types of burst requests. This is merely one example, and the method is not limited to memories having addresses aligned at 64-bit boundaries. Having determined the memory address boundary, the memory request instructs the memory 110 to transfer the specified amount of data in a single transfer beginning at the address boundary.

The appropriate slave 202 or 204 transfers the specified amount of data between the buffer (206, 208 or 212) and the first bus (172 or 174) in a plurality of beats. For example, in the case of a data read request, in which 64 bytes are transferred to the buffer DB₋Rx₋DataBuf 206, the slave 202 then performs sixteen 1-beat (4 byte) transfers from DB₋Rx₋DataBuf buffer 206 to AHB DB 172.

In a similar manner, if a 16-beat incrementing burst is going to write data to memory 110, slave 202 performs sixteen 1-beat transfers from AHB DB 172 to buffer DB₋Tx₋DataBuf 208, and the data are transferred from buffer DB₋Tx₋DataBuf 208 to memory 110 in a single 64 byte burst.

If a 16-beat incrementing burst is to read instructions from memory 110, 64 bytes are transferred from memory 110 to buffer IB₋Rx₋DataBuf 212 in a single burst, and then slave 204 performs sixteen 1-beat transfers to AHB IB 174. Although examples of 16-beat incrementing burst transfers are provided, one of ordinary skill understands that the same method is used for 4 and 8 beat incrementing bursts.

If the request is for a wrapping burst data transfer, then the transfer between the AHB DB 172 and the buffer 206 or 208 is performed as a series of beats according to the wrapping request, beginning with the location specified in the original request. In the exemplary DDR memory 110, read or write operations begin at addresses that are aligned with 4-byte word boundaries. On the other hand, the AMBA AHB bus 172, 174 allows wrapping burst transfers to begin anywhere within a word. For a wrapping burst transfer, the order in which the individual bytes are transferred between buffer 206, 208 and AHB DB 172 differs from the order in which the bytes are transferred between the buffer 206 or 208 and the DDR memory 110.

For example, if an 8-beat wrapping burst data read request begins at byte number 4, the data bytes are transferred from memory 110 to DB₋Rx₋DataBuf 206 in a single burst in the following byte order: 0-1-2-3-4-5-6-7. Then the data are transferred from DB₋Rx₋DataBuf 206 to AHB DB 172 in 8 beats in the following order 4-5-6-7-0-1-2-3.

If an 8-beat wrapping burst instruction read request begins at byte number 6, the instruction bytes are transferred from memory 110 to IB₋Rx₋DataBuf 212 in a single burst in the following byte order: 0-1-2-3-4-5-6-7. Then the instructions are transferred from IB₋Rx₋DataBuf 212 to AHB IB 174 in 8 beats in the following order 6-7-0-1-2-3-4-5.

If an 8-beat wrapping burst data write request begins at byte number 2, the data are transferred from AHB DB 172 to DB₋Tx₋DataBuf 208 in 8 beats in the following order 2-3-4-5-6-7-0-1. Then the data bytes are transferred from DB₋Tx₋DataBuf 208 to memory in a single burst in the following byte order: 0-1-2-3-4-5-6-7.

Although the handling of wrapping burst transfers is described above with reference to 8-beat wrapping burst transfers, the same approach is applicable to 4-beat wrapping burst and 16-beat wrapping burst transfers.

Using the buffers 206, 208 and 212 in the manner described above, the exemplary apparatus is capable of supporting any of the wrapping burst transfers with a single memory access request, and a single burst transfer between the memory 110 and the appropriate buffer 206, 208 or 212. The wrapping burst transfers from buffer 206 to AHB DB 172, from AHB DB 172 to buffer 208, and the transfers from buffer 212 to AHB IB 174 are performed using the specified number of beats and the specified starting address (which can be anywhere within the word).

FIG. 2 also shows the data flows among the various elements of the apparatus. AHB₋slave 202 provides a transmit FIFO control signal (Tx fifo ctrl) to DB₋Rx₋DataBuf buffer 206, and receives data bus read data (db_rd_data) and data bus read acknowledgement (db_rd_ack) from DB₋Rx₋DataBuf buffer 206. AHB₋slave 202 also provides data bus write data (db₋wr₋data) to data bus transmit buffer (DB_Tx_DataBuf) 208, and provides the data bus read request (db₋rd_rqst) to request forming unit 210, and receives the data bus write acknowledgement (db_wr₋ack) from DB₋Tx₋DataBuf 208.

DB₋Rx₋DataBuf 206 receives data bus request data (db₋rqst_data) and data bus request data valid bits (db₋rqst_valid) from memory interface 161. DB₋Tx₋DataBuf 208 transmits data bus write data (db_wr_data) to the memory interface 161 and data bus write request (db_wr_rqst) to request forming unit 210. DB₋Tx₋DataBuf 208 receives a data bus write grant from request forming unit 210.

AHB₋slave 204 provides a transmit FIFO control signal (Tx fifo ctrl) to IB₋Rx₋DataBuf buffer 212, and receives instruction bus read data (ib_rd_data) and instruction bus read acknowledgement (ib_rd_ack) from IB₋Rx₋DataBuf buffer 212. AHB₋slave 204 also provides the instruction bus read request (ib₋rd₋rqst) to request forming unit 210.

IB₋Rx₋DataBuf 212 receives instruction bus request data (ib₋rqst_data) and instruction bus request data valid bits (ib₋rqst_valid) from memory interface 161.

Request forming unit 210 provides an AHB DB/IB request (ahb_dbib₋rqst) to the memory interface 161, and a DB/IB request (dbib₋rqst) to MAS 178. Request forming unit 210 receives the DB/IB request grant from MAS 178.

The exemplary apparatus of FIG. 2 provides an efficient way for the AMBA AHB DB 172 and IB 174 to access the shared memory 110 in any of the burst modes with specified length as defined in AMBA Specification (Rev2.0).

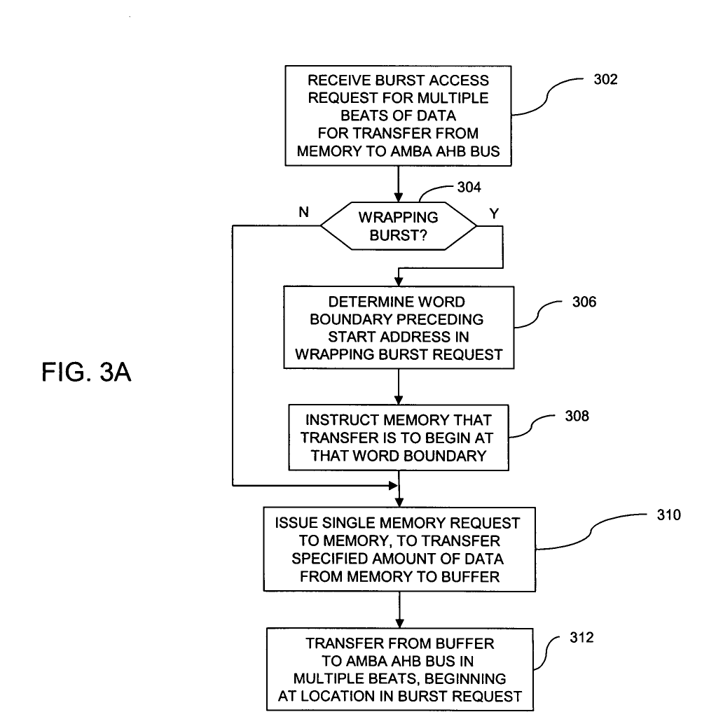

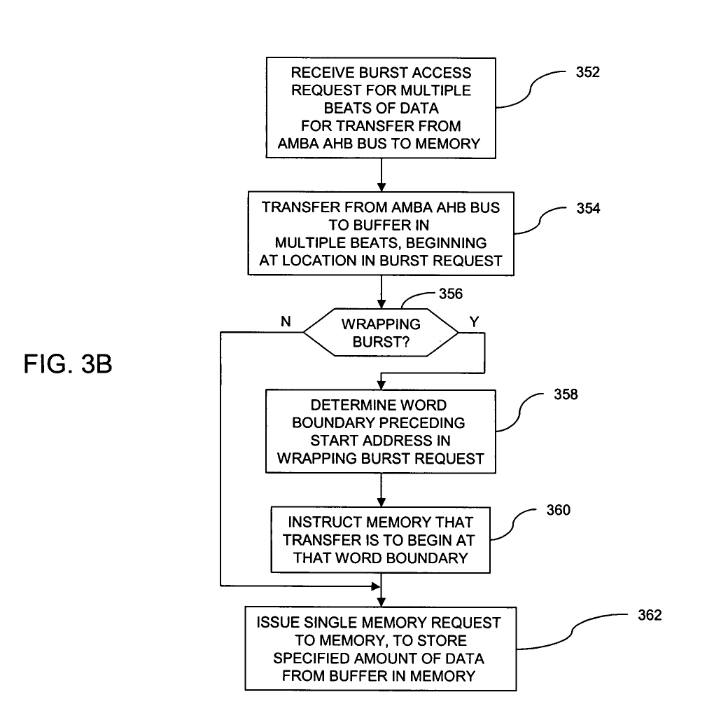

FIG. 3A is a flow chart showing an exemplary method for transferring data/instructions from memory to one of the AMBA AHB buses 172, 174.

At step 302, a burst access request of a type spanning multiple beats is received, for transferring data or instructions from memory 110 to one of the AMBA AHB buses 172, 174.

At step 304, a determination is made whether the request is for a wrapping burst. If a wrapping burst is requested, steps 306-308 are performed. If an incremental burst transfer is requested, step 310 is executed next. In alternative embodiments (not shown), a calculation is used to determine the word boundary for both incrementing and wrapping bursts, and steps 306 and 308 are replaced by a general step of determining the word boundary.

At step 306, the word boundary preceding the start address of the wrapping burst request is determined.

At step 308, the memory controller 160 is instructed that the burst transfer is to begin at the word boundary determined in step 306.

At step 310, a single memory access request is issued to the memory 110, to transfer the entire amount of the burst transfer from the memory to the appropriate buffer 206 or 212 corresponding to the destination AHB bus 172 or 174

At step 312, the data are transferred from the buffer 206 or 212 to the corresponding AHB bus 172 or 174 in multiple beats, beginning at the location specified in the original burst transfer request.

AMBA AHB IB Read Shared Memory Operation

Once an instruction read request by AHB IB 174 is granted, the request is forwarded to the memory controller 160 (FIG. 1) via the TMA-memory interface 161 (FIG. 2). The IB₋Rx₋DataBuf 212 stores the requested instructions and re-assembles the instructions according to the burst type and start address.

When the requested instructions come back from shared memory 110, the IB₋Rx₋DataBuf 212 stores them into a buffer (e.g., a register, not shown) within IB₋Rx₋DataBuf 212. (in some embodiments, the size is 16*4 bytes to handle up to a 16-beat burst). The received instructions are stored into the buffer depending on the start address of the burst transfer and the memory access request start address (for wrapping bursts, these two parameters may be different). After all the data have been received by the data buffer, the IB₋Rx₋DataBuf 212 responds by providing the correct data (ib_rd_data) on AHB IB 174 according to the AHB IB address bus along with the acknowledgement response (ib_rd_ack). In other embodiments, the data for a wrapping burst are stored in ascending order and read out to AHB IB 174 beginning at the requested burst start address and wrapping around to the lowest address.

After the IB burst request has been serviced, the AHB IB 174 is released for further access.

AMBA AHB DB Read Shared Memory Operation

AHB DB 172 may read the shared memory 110 to receive control traffic from the network interface 131 or disk 141, or to extract packets from an existing media session in shared memory 110.

The AHB DB read operation is similar as the AHB IB read operation except that a separate buffer Rx₋DataBuf 206 is used. AMBA AHB slave device 202 detects the start of a burst transfer, burst type, start address and request type (read/write). When an AHB DB read burst transfer is detected, the AHB DB 172 waits, and the relevant information is provided to request forming unit 210.

Request Forming unit 210 forms the read access request (dbib₋rqst) and arbitrates the DB read access. Once the AHB DB read request is granted, the request is forwarded to the memory controller 160 via the TMA-memory interface 161. For a wrapping burst access, request forming unit 210 determines the lowest address to be read as the request address to be forwarded to memory controller 160. As a result, the data fed back by the shared memory 110 begin at the lowest address in memory. DB_Rx₋DataBuf 206 stores the requested data into a data buffer (e.g., a register, not shown, within DB₋Rx₋DataBuf), and re-assembles the data according to the burst type. After all the data are received, DB₋Rx₋DataBuf 206 responds with the requested data db₋rd₋data on the DB data bus 172, along with the acknowledgement response db₋rd_ack.

After the DB burst request has been serviced, the AHB DB 172 is released for further access.

FIG. 3B is a flow chart showing an exemplary method for transferring data/instructions from AMBA AHB bus 172 to memory 110.

At step 352, a burst access request of a type spanning multiple beats is received, for transferring data from AMBA AHB bus 172 to memory 110.

At step 354, the data are transferred from AHB bus 172 to the buffer 208 in multiple beats, beginning at the location specified in the original burst transfer request.

At step 356, a determination is made whether the request is for a wrapping burst. If a wrapping burst is requested, steps 358-360 are performed. If an incremental burst transfer is requested, step 362 is executed next. In alternative embodiments (not shown), a calculation is used to determine the word boundary for both incrementing and wrapping bursts, and steps 358-360 are replaced by a general step of determining the word boundary.

At step 358, the word boundary preceding the start address of the wrapping burst request is determined.

At step 360, the memory controller 160 is instructed that the burst transfer is to begin at the word boundary determined in step 358.

At step 362, a single memory access request is issued to the memory 110, to transfer the entire amount of the burst transfer from buffer 208 to the memory.

AMBA AHB DB Write Shared Memory Operation

The AMBA AHB Data Bus 172 may insert packets into an existing media session for packet re-ordering purposes or write data to disk 141.

AMBA AHB slave device 202 detects the start of a burst, burst type, start address and request type (read/write). For an AHB DB burst write transfer, the data to be written are stored into a register (not shown) within DB₋Tx₋DataBuf 208 (in some embodiments, the register size is 16*4 bytes to handle burst types up to 16-beats). In some embodiments, the data are written into a specific position within the register depending on the 16 possible DB address offsets, so that when the data are read out from DB₋Tx₋DataBuf 208 in ascending order, the byte to be stored at the lowest address in memory 110 is read first. When the DB₋Tx₋DataBuf control logic determines that the last beat is received from AHB DB 172, the control logic stores the data into DB₋Tx₋DataBuf 208 without feeding back an acknowledgement to slave device 202. AHB data bus 172 waits until it receives the acknowledgement for the last beat write. Meanwhile, the DB₋Tx₋DataBuf 208 issues a write request to request forming unit 210.

Request forming unit 210 forms the AHB DB/IB access request and arbitrates the DB/IB access. Once the AHB DB write request is granted, the request is forwarded to the shared memory 110. For a wrapping burst access, request forming unit 210 determines the lowest address as the request address to be forwarded to memory, if the start address of the transfer is not aligned to the total number of bytes in the burst (size×beats).

When request forming unit 210 indicates that the write access has been granted by MAS 178, DB₋Tx₋DataBuf 208 re-assembles the request data from its register and sends the data to the shared memory 110. When all the data are transmitted to memory 110, DB₋Tx₋DataBuf 208 feeds back a write acknowledgement db₋wr₋ack as the last beat write acknowledgement to AHB slave device 202 to release the AHB DB 172 for further operations.

Arbitration

Referring again to FIG. 2, the request forming unit 210 also includes a means for arbitrating among instruction bus read requests, data bus read requests and data bus write requests. Whereas MAS 178 schedules accesses to memory 110 from a variety of requestors, the arbitrating means determines which of a plurality of DB/IB bus requests is serviced by MAS 178 at any given time. Completion of a data or instruction transfer between one of the AMBA AHB buses 172, 174 and memory 110 includes scheduling operations by both the request forming unit 210 and MAS 178. The operation and structure of the MAS 178 may be as described in U.S. patent application Ser. No. 11/273,750, filed Nov. 15, 2005, which is incorporated by reference herein in its entirety.

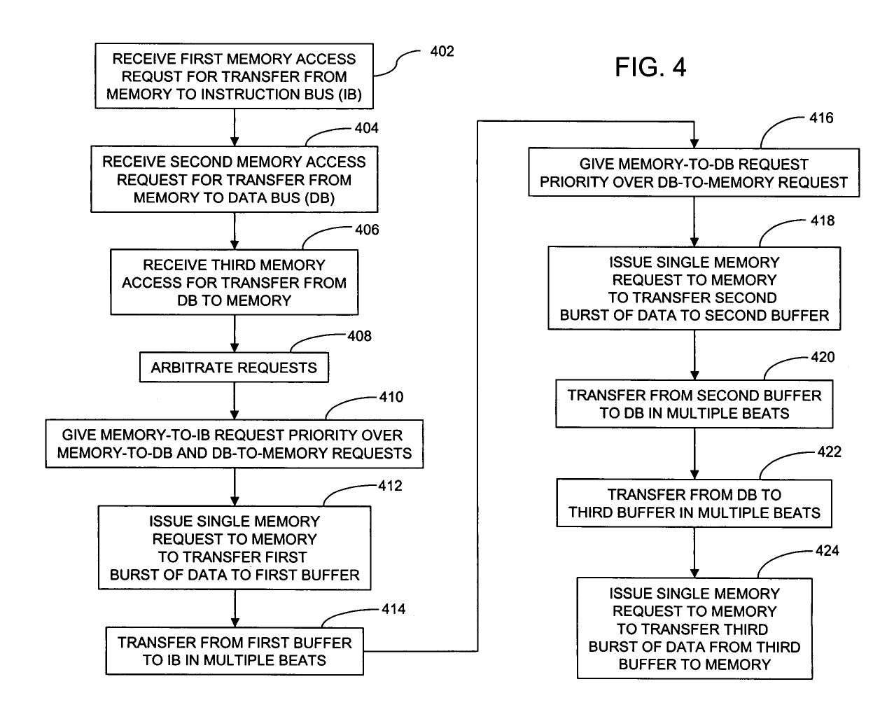

FIG. 4 is a flow chart showing the arbitrating functions performed by an exemplary request forming unit 210. Request forming unit 210 determines which bus request is to be serviced first whenever there are at least two request types from the group that includes data bus read request, data bus write request, and instruction bus read request. Thus, request forming unit 210 can prioritize between a data bus read and a data bus write, between a data bus read and an instruction read, and/or between a data bus write and an instruction read.

At step 402, request forming unit 210 receives a first memory access request from slave 204 for a data transfer from memory 110 to AHB IB 174.

At step 404, request forming unit 210 receives a second memory access request for a transfer from memory 110 to AHB DB 172.

At step 406, request forming unit 210 receives a third memory access request for a transfer from AHB DB 172 to memory 110. Although in the example of FIG. 4, the requests are received in a particular order, the three requests may be received in any order. The order of receipt does not change the result if all of the requests are received prior to the arbitration by request forming unit 210.

At step 408, request forming unit 210 performs the arbitration using predetermined rules. In some embodiments, when arbitrating between first, second and third burst access requests for access to the memory 110, request forming unit 210 gives the first burst access request priority over the second and third burst access requests.

For example, at step 410 request forming unit 210 may give requests from AHB IB 174 priority over all memory access requests by AHB DB 172 and give data bus read operations priority over data bus write operations.

In some embodiments, the priorities used by request forming unit 210 are programmable via a register to allow other priority rules, such as assigning higher priority to AHB DB requests. AP 150 can write the priority rule data to a register (not shown) in request forming unit 210 to implement any desired priority scheme. For example, the register may list the request types in order of priority, with the type having highest priority listed first and the type having lowest priority listed last. The rule can be changed by overwriting the list with the request types in a different order. Alternatively, the register may include respective fields for the priority of each request type in a specified order, with the value written to each field determining the priority of that type. The request forming unit 210 thus provides flexible bandwidth allocation.

At step 412, request forming unit 210 issues a single memory request (dbib₋rqst) to memory interface 161 to transfer the first burst of instructions from the memory 110 to the first buffer IB₋Rx₋DataBuf 212. The transfer from memory to buffer 212 is as described above with reference to FIG. 3A.

At step 414, the instructions are transmitted from buffer IB₋Rx₋DataBuf 212 to IB 174. If the request is for a 4, 8 or 16 beat burst, then the transfer is performed in 4, 8 or 16 beats.

At step 416, request forming unit 210 gives the second burst access request priority over the third burst access request. For example, burst transfers from memory 110 to data bus 172 (data read) may be given priority over transfers from DB 172 to memory 110 (data write).

At step 418, request forming unit 210 issues a single memory request (dbib₋rqst) to memory interface 161 to transfer the second burst of data (data read) from the memory 110 to the second buffer DB₋Rx₋DataBuf 206. The transfer from memory 110 to buffer 206 is as described above with reference to FIG. 3A.

At step 420, the data are transferred from DB₋Rx₋DataBuf 206 to AHB DB 172. If the transfer is a multiple beat burst transfer, then the data are delivered to AHB DB 172 in a plurality of beats.

At step 422, the data to be written to memory 110 are transferred from AHB DB 172 to the third buffer DB₋Tx₋DataBuf 208. If the burst access request is of a multiple-beat type, then the transfer is performed in a plurality of beats.

At step 424, request forming unit 210 issues a single request to memory interface 161 to transfer the third burst transfer (write data) from the third buffer DB₋Tx₋DataBuf 208 to memory 110 in a single burst.

The exemplary embodiments described above support all the AHB burst modes with specified length defined in AMBA Specification (Rev 2.0), while reducing overhead for memory accesses. A single burst access request of any type is handled by a single memory access request gracefully with various lengths from 1 beat to 16 beats. The same method can be adapted to support future burst transfer standards that may permit bursts with different numbers of beats (e.g., 32 or 64 beats). The method described above is not impeded by any shared memory behavior, such like long delay time, or a break in the middle of a burst transfer. The methods described herein provide improved system performance without using strict priority for AP 150 over any other modules that access the shared memory 110. This method does not prevent achievement of other system performance goals, such as meeting quality of service requirements for media streams.

Although the exemplary system described above does not include instruction bus write requests, other embodiments (not shown) may include an instruction bus write request type, in which case request forming unit 210 arbitrates among four different request types. For example, in one such embodiment, request forming unit 210 uses a strict priority scheme to issue memory requests on behalf of instruction bus read, data bus read, data bus write, and instruction bus write operations, in that order.

Examples are provided above in which three types of requests from two AMBA AHB buses are arbitrated and serviced. The methods described above are not limited to AMBA AHB buses, but may be applied to systems including other types of busses that access a shared memory. The methods described above are not limited to systems having two buses, but may be applied to other systems having one or more bus. The methods described above are not limited to systems having three request types, but may applied to other systems having two or more request types. The methods described above are not limited to systems in which a strict priority rule is used between the various request types, but may be used with any desired priority rule for determining the order in which various memory access requests are serviced.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method comprising the steps of:
receiving a burst access request for transfer of data between a memory and a first bus, wherein the burst access request specifies an amount of data that is at least a multiple of an amount of data transferred in one beat;
issuing a single memory request instructing the memory to transfer the specified amount of data between the memory and a buffer coupled to the first bus;
transferring the specified amount of data between the buffer and the first bus in a plurality of beats.

2. The method of claim 1, wherein the first bus is an advanced microcontroller bus architecture advanced high-performance bus.

3. The method of claim 1, wherein the burst access request specifies a wrapping burst.

4. The method of claim 3, further comprising:
determining an address boundary in the memory preceding a starting address specified in the burst access request,
wherein the memory request instructs the memory to transfer the specified amount of data beginning at the address boundary.

5. The method of claim 1, further comprising:
receiving a second burst access request for transfer of a second amount of data between the memory and a second bus; and
arbitrating between the first and second burst access requests for access to the memory; and
issuing an additional memory request instructing the memory to transfer the second amount of data between the memory and a second buffer coupled to the second bus, and transferring the specified amount of data between the second buffer and the second bus in a plurality of beats.

6. The method of claim 5, wherein the first bus is an instruction bus, the second bus is a data bus, and the first burst access request is given priority over the second burst access request.

7. The method of claim 1, wherein the first bus is a data bus, and the burst access request specifies transferring the amount of data from the memory to the data bus, the method further comprising:
receiving a second burst access request for transfer of a second amount of data from the data bus to the memory;
arbitrating between the first and second burst access requests for access to the memory; and
after issuing the single memory request, issuing an additional memory request instructing the memory to transfer the second amount of data from a second buffer to the memory, the second buffer being coupled to the data bus.

8. The method of claim 1,
wherein the first bus is an instruction bus,
the method further comprising:
receiving a second burst access request for transfer of a second amount of data from the memory to a data bus;
receiving a third burst access request for transfer of a third amount of data from the data bus to the memory;
arbitrating between the first, second and third burst access requests for access to the memory, including giving the second burst access request priority over the third burst access request, and giving the first burst access request priority over the second and third burst access requests; and
after issuing the single memory request, issuing a second memory request instructing the memory to transfer the second amount of data from the memory to a second buffer coupled to the data bus, and then issuing a third memory request instructing the memory to transfer the third amount of data from a third buffer to the memory, the third buffer being coupled to the data bus.

9. Apparatus comprising:
a first bus;
a first slave that receives a burst access request for transfer of data between a memory and the first bus, wherein the burst access request specifies an amount of data that is at least a multiple of an amount of data to be transferred in one beat;
a buffer coupled to the first slave; and
a request forming unit for issuing a single memory request instructing the memory to transfer the specified amount of data between the memory and the buffer;
wherein the slave transfers the specified amount of data between the buffer and the first bus in a plurality of beats.

10. The apparatus of claim 9, wherein the first bus is an advanced microcontroller bus architecture advanced high-performance bus.

11. The apparatus of claim 9, wherein the request forming unit comprises means for determining an address boundary in the memory preceding a starting address specified in the burst access request,
wherein the memory request instructs the memory to transfer the specified amount of data beginning at the address boundary.

12. The apparatus of claim 9, further comprising:
a second bus;
a second slave that receives a second burst access request for transfer of a second amount of data between the memory and the second bus;
an arbitrator that arbitrates between the first and second burst access requests for access to the memory; and
a second buffer coupled to the second bus,
wherein the request forming unit issues an additional memory request instructing the memory to transfer the second amount of data between the memory and the second buffer, and
the second slave transfers the specified amount of data between the second buffer and the second bus in a plurality of beats.

13. The apparatus of claim 12, wherein the first bus is an instruction bus, the second bus is a data bus, and the first burst access request is given priority over the second burst access request.

13. The apparatus of claim 9, wherein:
the first bus is a data bus, and the burst access request specifies transferring the amount of data from the memory to the data bus, and
the slave receives a second burst access request for transfer of a second amount of data from the data bus to the memory;
the apparatus further comprises an arbitrator that arbitrates between the first and second burst access requests for access to the memory; and
after issuing the single memory request, the request forming unit issues an additional memory request instructing the memory to transfer the second amount of data from a second buffer to the memory, the second buffer being coupled to the data bus.

14. The apparatus of claim 9,
wherein the first bus is an instruction bus,
the apparatus further comprising:
a second slave that receives a second burst access request for transfer of a second amount of data from the memory to a data bus and receives a third burst access request for transfer of a third amount of data from the data bus to the memory; and
an arbitrator, coupled to the first and second slaves, that arbitrates between the first, second and third burst access requests for access to the memory, the arbitrator giving the second burst access request priority over the third burst access request, and giving the first burst access request priority over the second and third burst access requests; and
second and third buffers coupled to the second bus,
wherein, after issuing the single memory request, the request forming unit issues a second memory request instructing the memory to transfer the second amount of data from the memory to the second buffer, and then issues a third memory request instructing the memory to transfer the third amount of data from the third buffer to the memory.
